(19) United States
(12) Patent Application Publication
(10) Pub. No.: US 2014/0053149 A1
(43) Pub. Date: Feb. 20, 2014

(54) FAST AND AUTOMATIC DEPLOYMENT METHOD FOR CLUSTER SYSTEM

(71) Applicant: SYSTEX SOFTWARE & SERVICE CORPORATION, Taipei City (TW)

(72) Inventors: JENG-HSUEH WU, TAIPEI CITY (TW); CHAO-YU CHEN, TAIPEI CITY (TW); HUNG-LIANG SHIH, TAIPEI CITY (TW)

(73) Assignee: SYSTEX SOFTWARE & SERVICE CORPORATION, Taipei City (TW)

(21) Appl. No.: 13/949,400

(22) Filed: Jul. 24, 2013

(30) Foreign Application Priority Data
Aug. 17, 2012 (TW) 101129904

(51) Int. Cl. G06F 9/445

(52) U.S. Cl. CPC G06F 8/61
USPC 717/176

(57) ABSTRACT

Disclosed is a fast and automatic deployment method for a cluster system by using a ramdisk. A master node is provided for sending a kernel and a system image file after pre-booting at least one worker node in a cluster system via a network. The worker node claims segments of installed RAM to form a ramdisk and buffer the system image file, and after the kernel is executed to install the system image file, a register signal is sent to the master node to request a configuration profile, and related service setup and OS installation are completed by self-setting. Therefore, the fast reading property of the RAM expedites the effect of building and automatically deploying the entire cluster system to simplify the construction complexity and maintenance effort and operation costs.

### CROSS-REFERENCE TO RELATED APPLICATIONS

This non-provisional application claims priority under 35 U.S.C. §119(a) on Patent Application No(s). 101129904 filed in Taiwan. R.O.C. on Aug. 17, 2012, the entire contents of which are hereby incorporated by reference.

### BACKGROUND OF THE INVENTION

1. Field of the Invention

The present invention relates generally to the field of building and deploying diskless cluster systems, and more specifically to a fully automated deployment method for a cluster system by using Random Access Memory (RAM) disk to expedite the delivery of system images, improve the efficiency of building and deploying a cluster system, and reduce the maintenance effort, operation and update costs of the entire cluster system.

2. Description of the Related Art

Thanks to the technology of Preboot eXecution Environment (PXE), a master node can initiate the system installation and boot computing apparatuses such as networked diskless servers or end-user computers and allow the computing apparatuses to automatically set up an operating environment to expedite scalable operating system (OS) deployment within a data center, a enterprise-grade telecommunication fabric infrastructure, or a computer classroom, so that cluster system related applications become a feasible fact. With reference to FIG. 1 for a schematic view of the architecture of most existing diskless systems bootable via a network, a remote PXE server 1 is connected to a network adapter 20 of at least one managed endpoint 2 through Dynamic Host Configuration Protocol (DHCP) or Trivial File Transfer Protocol (TFTP) to initiate preboot loader process to fetch system kernel and RAM disk automatically from managed endpoint 2 to install an OS. The PXE server 1 has a database 10 for storing a plurality of OS files, a plurality of bootstrap loaders, a plurality of user-defined IP addresses and configuration profiles. When the managed endpoint 2 requests an IP address from the PXE server 1, the PXE server 1 assign an IP address stored in the database 10 to the managed endpoint 2 by the DHCP, and then the managed endpoint 2 obtains the IP address and requests the corresponding bootstrap loader and configuration profile from the PXE server 1. After the PXE server 1 transmits the bootstrap loader and configuration profile through the TFTP, the managed endpoint 2 selects a defined kernel and associated boot parameters from the configuration profile to download the kernel and compressed ramdisk image. Finally, the managed endpoint 2 boot the kernel and decompressed ramdisk in system memory and request from the PXE server 1 to load a system service configuration settings to the managed endpoint 2, so as to complete the installation procedure of a networked diskless server.

In the conventional way of downloading and saving the aforementioned programs by a file system created on a physical disk, the speed of downloading and installing the programs is limited by the reading and writing of the hard disk. For example, a large data center takes approximately seven days to build 100˜1000 servers, and thus incurring high operation costs and resulting in low execution efficiency. As to the properties of the magnetic layers, electronics and mechanical system of the hard disk, a long-term drive usage may produce bad sectors and cause abnormal operations of the cluster system easily, thus increasing the maintenance effort and operation costs and the complexity of the equipment and system. Therefore, it is a main subject of the present invention to overcome the problem of the low operation efficiency and the high maintenance effort and operation costs caused by the properties of the hard disk.

### SUMMARY OF THE INVENTION

In view of the problems of the prior art, it is a primary objective of the present invention to overcome the problems and provide a fast and automatic deployment method for a cluster system by using a ramdisk to improve the efficiency of setting the OS of the computing apparatus and simplify the level of difficulty and complexity of building the entire cluster system.

To achieve the aforementioned objective, the present invention provides a fast and automatic deployment method for a cluster system by using a ramdisk that controls at least one worker node in a cluster system by a master node via a network to boot the worker node to automatically install and configure an OS. The method comprises the steps of: powering on the worker node; sending a DHCP network address request to the master node by the worker node to obtain an pre-defined network address according to configuration database; feeding back a checksum and sending a system installation request to the master node by the worker node after a preboot loader is executed; sending a kernel and a system image file to the worker node by the master node via the network when the checksum is correct, and claim RAM segments to form a ramdisk by the worker node for buffering the system image file; executing the kernel, installing the system image file by the worker node, and sending a register signal to the master node; and sending a corresponding configuration profile to the worker node when the master node receives the register signal, and using the configuration profile for an automatic setup by the worker node to complete installing the OS.

In short, the fast and automatic deployment method for cluster system by using a ramdisk of the present invention that controls at least one worker node in a cluster system by a master node via a network to boot the worker node to automatically install and configure an OS is characterized in that the worker node claim RAM segments installed therein to form a ramdisk for receiving a kernel, a system image file and a corresponding configuration profile from the master node, and after the worker node fetch the system kernel and install the system image file, an automatic setup is performed according to the configuration profile to complete the installation of the OS.

Wherein, if it is necessary to add at least one worker node to the cluster system the method further comprises the step of: setting hardware configuration information and application program information of the worker node in a configuration database of the master node to generate the configuration profile of the worker node, before powering on the worker node.

The master node applies a system provision configuration to boot the worker node via the network. If the worker node executes the preboot loader and feeds back an incorrect checksum, the master node will reset the worker node again via the network to re-assign the network address to the worker node, and the worker node will execute the preboot loader again.

To allow users to adjust the equipment architecture of the cluster system flexibly, the method of the invention further comprises the steps of deleting the configuration profile of the worker node in the configuration database; powering off the worker node by the master node via the network; and releasing the kernel, the system image and the configuration profile from the claimed RAM segments to offline the worker node from the cluster system. After the worker node completes the installation of the OS, users can immediately update the kernel, the system image file and the configuration profile of the worker node in the configuration database, and the master node turns off and reboots the worker node via the network, and the worker node requests the kernel, the system image file and the configuration profile again to install the OS, so as to complete updating the system. Therefore, if the cluster system has a large quantity of worker nodes, the users still can all updates at a time through the master node to simplify the level of difficulty and complexity of the system maintenance. In addition, system versions can be updated immediately to reduce the possibility of abnormal operations caused by the program.

On the other hand, when the worker node installs an application program, the worker node notifies current deployment status back to the master node to update the corresponding configuration profile in the configuration database, and the worker node has a hard disk for storing the application program and application data. Therefore, after the worker node is powered off, the users still can maintain a portion of the application program and the application data.

In summation of the description above, the fast and automatic deployment method for cluster system by using a ramdisk in accordance with the present invention, RAM segments is claimed to form a ramdisk to expedite the operation of saving the data including the system boot image file and the configuration profile, so that when the cluster system has a large quantity of worker nodes, the installation time of the OS can be reduced significantly to improve the efficiency of constructing the cluster system effectively. In addition, the ramdisk generally has the property of a longer service lifetime and less strain, so that the system reliability of the worker node can be improved, and the maintenance cost of the cluster system and equipment can be reduced.

### BRIEF DESCRIPTION OF THE DRAWINGS

FIG. 1 is a schematic view showing the architecture of a conventional way of booting a diskless system by a network;

FIG. 2 is a schematic view showing the architecture of a preferred embodiment of the present invention;

FIG. 3 is a flow chart of a preferred embodiment of the present invention; and

FIG. 4 is another flow chart of a preferred embodiment of the present invention.

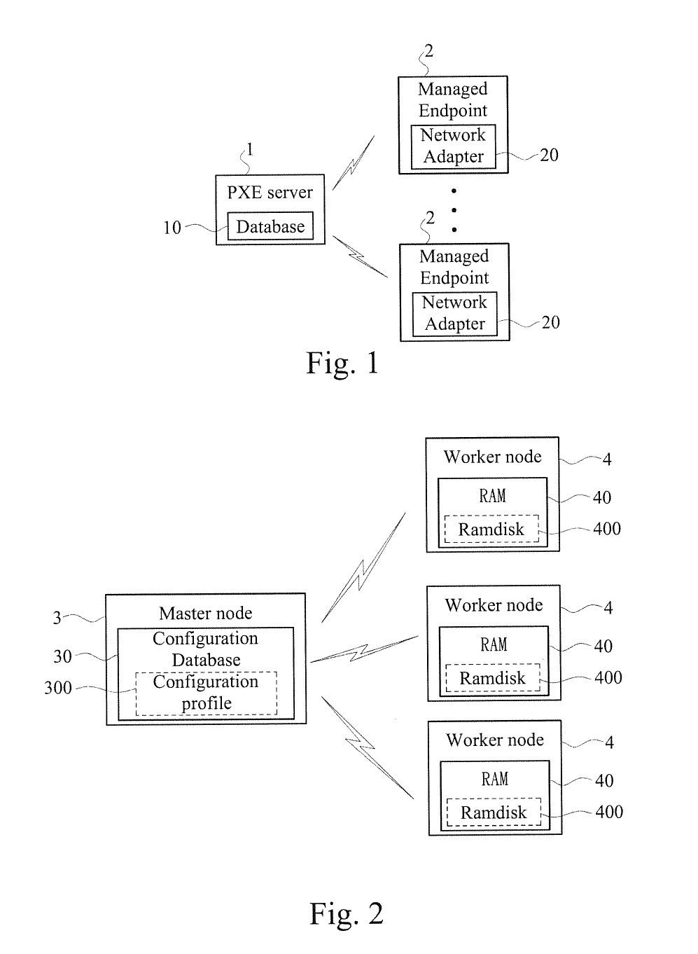

### DETAILED DESCRIPTION OF THE PREFERRED EMBODIMENTS

The technical content of the present invention will become apparent with the detailed description of preferred embodiments and the illustration of related drawings as follows.

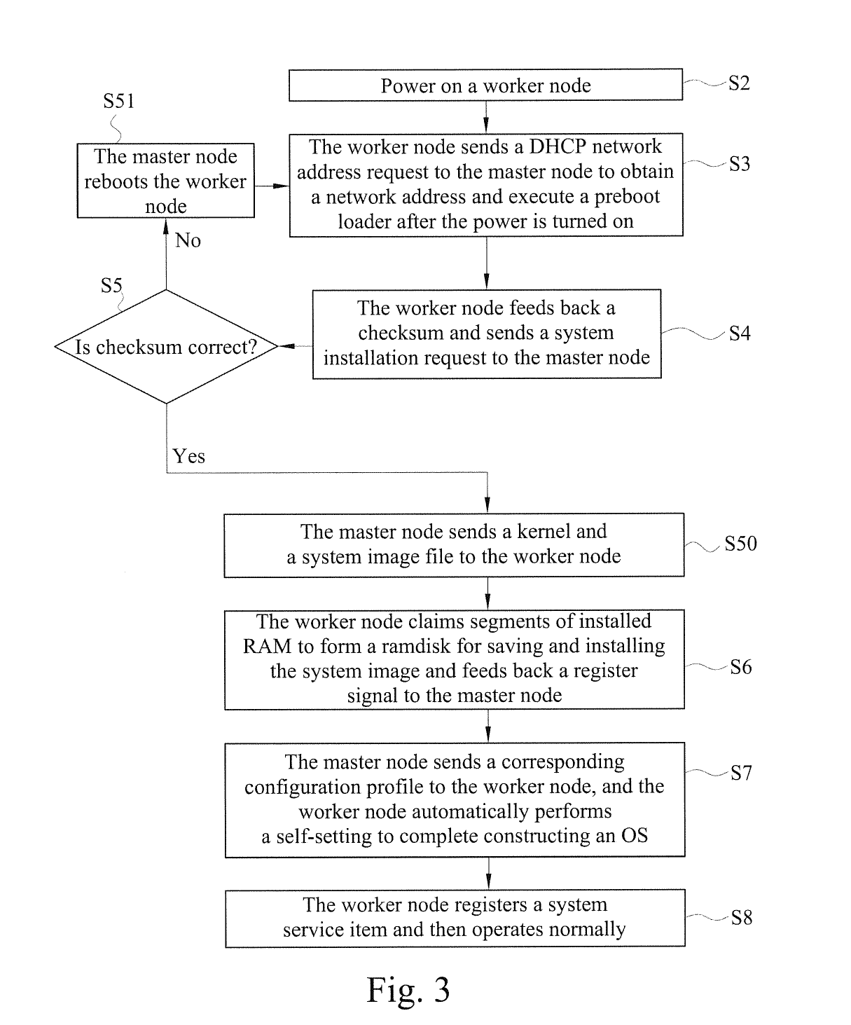

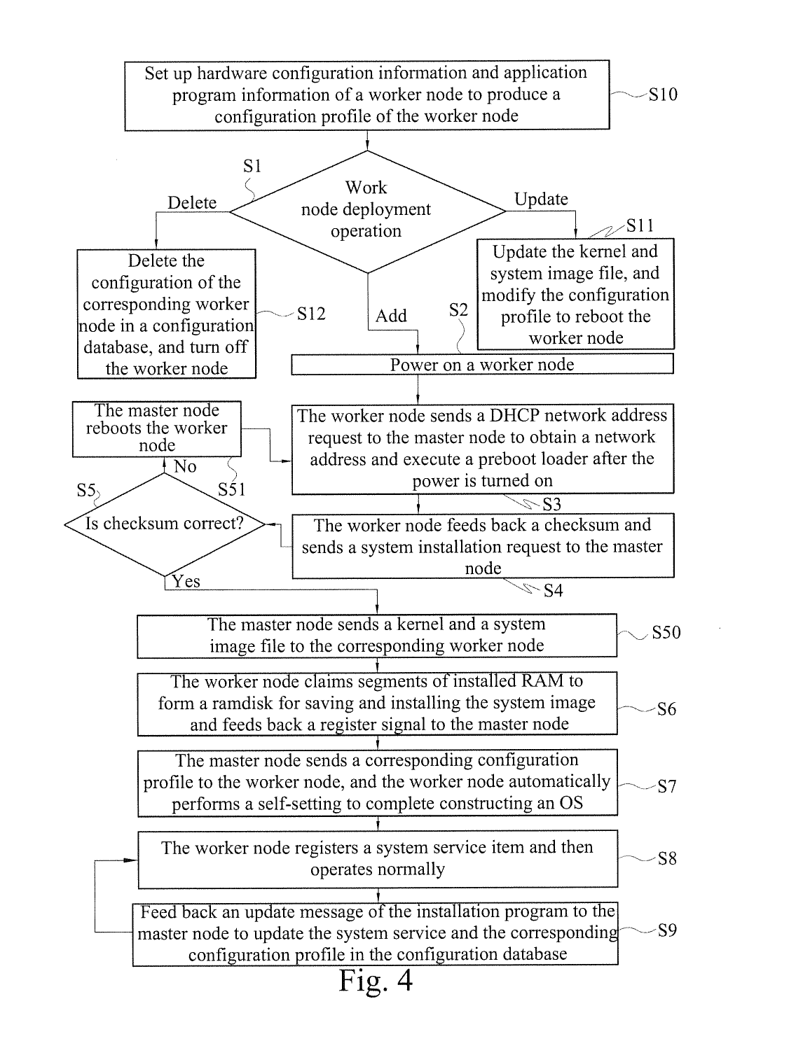

With reference to FIGS. 2 and 3 for a schematic view of the architecture and a flow chart of a fast and automatic deployment method for a cluster system by using a ramdisk in accordance with a preferred embodiment of the present invention respectively, the method is applicable for improving the efficiency of setting up computing apparatuses such as computers or servers to lower the construction time and cost of the cluster system of a data center, a enterprise-grade telecommunication fabric infrastructure or a computer classroom. The fast and automatic deployment method for cluster system by using a ramdisk mainly uses a master node 3 such as a terminal server to control the system architecture of a plurality of worker node 4 in a cluster system via a network, and the method comprises the following steps.

S2: The master node 3 executes a provision configuration. In other words, a user manually turns on the power of the worker node 4 or the master node 3 powers on the worker node 4 via a network, after the cluster system is initiated and related control software is executed.

S3: The worker node 4 sends a DHCP network address request to the master node 3 to obtain a network address and execute a preboot loader after the power is turned on.

S4: When the worker node 4 executes the preboot loader, the hardware configuration and the number of required files are checked, the worker node 4 feeds back a checksum to the master node 3. In the meantime, a system installation request is sent to the master node 3. It is noteworthy that the checksum and the system installation request include the network address of each worker node 4, so that each worker node 4 can request the required files correctly.

S5: The master node 3 receives the checksum and determines whether the checksum is correct. If the checksum is correct, the method will execute Step S50.

S50: The master node 3 sends a kernel and a system image file to the network address of the corresponding worker node 4 via the network.

If the checksum is incorrect, the method will execute Step S51.

S51: After the master node 3 reboots the worker node 4 that sends out an incorrect checksum via the network, the master node 3 re-assign the network address to the worker node 4, the worker node 4 executes the preboot loader again, checks and feeds back a checksum, and sends out a system installation request again.

S6: Each worker node 4 claims segments of installed RAM 40 to form a ramdisk 400. When the kernel and the system image file are received, the kernel and the system image file are written into the RAM 40 and buffered in the ramdisk 400. Each worker node 4 executes the kernel to install the system image and matches the hardware configuration, and transmits a register signal to the master node 3.

S7: After the master node 3 receives the register signal from each worker node 4, the register signals are integrated to assign a role to each of the worker node 4 in the cluster system to distinguish the task priority, assigned service or bandwidth usage of each worker node 4. Based on the register signals, the master node 3 sends a corresponding configuration profile 300 to each worker node 4, and each worker node 4 uses the configuration profile to automatically perform a self-setting to complete constructing an OS. In this preferred embodiment, the configuration profile 300 is stored in a configuration database 30 of the master node 3, and the kernel and the system image file are also stored in the master node 3. The configuration database 30 is mainly provided for containing and storing related system data, service data and configuration data of each worker node 4 (which are system service and configuration database).

S8: Each worker node 4 checks a default application service according to hardware configuration information and application program information of the configuration profile 300 and then registers the check result to the master node 3 to provide real-time system service status and operate normally. Therefore, the present invention can boot and automatically set a large quantity of worker node 4 in the cluster system all at a time. For example, it just takes approximately five minutes to build 100 sets of servers in a data center, so that the invention can improve the efficiency of constructing cluster system significantly and lower the construction cost effectively.

With reference to FIG. 4 for another flow chart of a preferred embodiment of the present invention, a user can add, update or delete any worker node 4 in the cluster system to facilitate adjusting the quantity of cluster nodes flexibly and maintaining the architecture of the cluster system through the master node 3. In other words, before the step S2 is carried out, the master node 3 can perform the step S1 first.

S1: Determine an actual operation of the worker node 4 controlled by a user. If the user wants to add a worker node 4 to the cluster system, Step S10 will be carried out.

S10: The user can modify data in the configuration database 30 directly to add hardware configuration information and application program information to produce a new record of configuration profile 300, and then the step S2 is carried out to execute the installation and configuration setting of the OS, so that the additional worker node 40 can be added to the target cluster system and managed by the master node 3.

When the version of the OS is updated, the step S11 is carried out.

S11: After the master node 3 produces and updates the kernel and the system image file and modifies the corresponding configuration profile 300 of the worker node 4 in the configuration database 30, the master node 3 turns off and reboots the worker node 4 via network, so that the worker node 4 requests the kernel, the system image file and the configuration profile to reconfigure the OS, and the worker node 4 can timely and automatically update the version of the system and reduce the possibility of abnormal operation.

If the user wants to remove a worker node 4 from the cluster system, Step S12 will be carried out.

S12: The master node 3 turns off the power of the worker node 4 via the network or manually by the user, after the corresponding configuration profile 300 of the worker node 4 in the configuration database 30 is deleted. Therefore, the kernel, the system image and the configuration profile stored in the RAM 40 of the worker node 4 are released immediately and removed from the cluster system.

Particularly, after each worker node 4 provides services as described in the step S8 the worker node 4 processes the step S9 to meet the operation requirements of different users and satisfy the user-friendly operation functions, if the user installs various application programs to the worker node 4 according to personal preference.

S9: Feed back an update message of the installation program to the master node 3 to update the system service and the corresponding configuration profile 300 in the configuration database 30. Since each worker node 4 has a hard disk, operation data including the application program, application data and other user's operation data can be stored. Therefore, each worker node 4 still can maintain a portion of data to facilitate users to continue their operation after a re-boot.

What is claimed is:

1. A fast and automatic deployment method for a cluster system by using a ramdisk, that controls at least one worker node in the cluster system by a master node via a network to turn on and drive the worker node to automatically install and configure an OS, comprising the steps of:
powering on the worker node;
sending a DHCP network address request to the master node by the worker node to obtain a network address;
feeding back a checksum and sending a system installation request to the master node by the worker node after a preboot loader is executed;
sending a kernel and a system image file to the worker node by the master node via the network when the checksum is correct, and claiming segments of installed random access memory (RAM) into the ramdisk by the worker node for buffering the system image file;
executing the kernel, installing the system image file by the worker node, and sending a register signal to the master node; and
sending a corresponding configuration profile to the worker node when the master node receives the register signal, and using the corresponding configuration profile for an automatic setup by the worker node to complete installing the OS.

2. The fast and automatic deployment method for the cluster system by using the ramdisk according to claim 1, wherein if it is necessary to add at least one worker node to the cluster system and before powering on the worker node, the method further comprises the step of:
setting a hardware configuration information and an application program information of the worker node in a configuration database of the master node to form the corresponding configuration profile of the worker node.

3. The fast and automatic deployment method for the cluster system by using the ramdisk according to claim 2, wherein the master node executes a provision configuration to power on the worker node via the network.

4. The fast and automatic deployment method for the cluster system by using the ramdisk according to claim 3, wherein if the checksum is incorrect, the method further comprises the steps of:
rebooting the worker node via the network by the master node to drive the worker node to execute the preboot loader again after the network address is re-assigned to the worker node.

5. The fast and automatic deployment method for the cluster system by using the ramdisk according to claim 2, wherein if the worker node completes the installation of the OS, the method further comprises the steps of:
deleting the corresponding configuration profile of the worker node in the configuration database;
powering off the worker node by the master node via the network; and
releasing the kernel, the system image and the corresponding configuration profile from the RAM to offline the worker node from the cluster system.

6. The fast and automatic deployment method for the cluster system by using the ramdisk according to claim 2, wherein after the worker node completes the installation of the OS, the method further comprises the steps of:
updating the kernel, the system image file and the corresponding configuration profile of the worker node in the configuration database;
the master node turn off and reboot the worker node via the network; and
requesting the kernel, the system image file and the corresponding configuration profile again by the worker node to reset the OS again to complete updating the OS.

7. The fast and automatic deployment method for the cluster system by using the ramdisk according to claim 2, further comprising the step of:
feeding back an update message to the master node by the worker node to update the corresponding configuration profile in the configuration database, if the worker node installs an application program.

8. The fast and automatic deployment method for the cluster system by using the ramdisk according to claim 7, wherein the worker node has a hard disk for storing the application program and application data.

9. A fast and automatic deployment method for a cluster system by using a ramdisk, that controls at least one worker node in a cluster system by a master node via a network to boot the worker node to automatically install and configure an OS, characterized in that the worker node claims segments of random access memory (RAM) installed therein to form the ramdisk for receiving and sending a kernel, a system image file and a corresponding configuration profile from the master node, and after the worker node executes the kernel to install the system image file, an automatic setup is performed according to the corresponding configuration profile to complete the installation of the OS.
